(19) United States
(12) Patent Application Publication
(10) Pub. No.: US 2008/0085629 A1
(43) Pub. Date: Apr. 10, 2008

(54) ELECTRICAL CONNECTOR STRUCTURE

(75) Inventors: Siou-Yi Hong, Hukou Township (TW); Lun-Ting Liu, Hukou Township (TW)

Correspondence Address: Troxell Law Office Pllc, Suite 1404, 5205 Leesburg Pike, Falls Church, VA, 22041, US

(73) Assignee: Singatron Enterprise Co., Ltd.

(21) Appl. No.: 11/543,974

(22) Filed: Oct. 6, 2006

(51) Int. Cl. H01R 13/66

(52) U.S. Cl. 439/541.5

(57) ABSTRACT

The present invention provides an improved connector structure in which a connector is structured from a conducting body, electric conducting terminals and fastening members, wherein terminals, which electrically connect with a circuit and connecting terminals, are disposed interior of the conducting body. The fastening members extend from the conducting body, and the fastening members enable the conducting body to embed into a circuit board, thereby enabling the connector to fasten into corresponding holes of the circuit board by means of the fastening members, and thus achieve the objective of increasing positioning strength.

### BACKGROUND OF THE INVENTION

(a) Field of the Invention

The present invention relates to an improved connector structure, and more particularly to a connector able to use a conducting body to fasten to a circuit board, and which utilizes the function of fastening members to increase positioning strength.

(b) Description of the Prior Art

Referring to FIGS. 1 and 2, which show a connector A of prior art, wherein the connector A is fitted to a circuit board B for use thereof, but lacks disposition of fastening devices, and merely uses terminals A1 of the connector A to connect to the circuit board by a soldering method. However, the soldering method easily results in the connector A rocking on the circuit board B when in use, which, after using for a long period of time, easily bringing about deformation or breaking of the terminals A1 of the connector A, thereby leading to concern over damage to the connector A or the terminals A1 coming loose. Hence, the inventor of the present invention proposes to resolve and surmount existent technical difficulties to eliminate the aforementioned shortcomings of prior art.

### SUMMARY OF THE INVENTION

The present invention relates to an improved connector structure, and more particularly to a connector able to use a conducting body to fasten to a circuit board, and which utilizes the function of fastening members to increase positioning strength, thereby enabling the connector to be firmly positioned on the circuit board, and achieve optimum electric conducting effectiveness.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view of prior art.

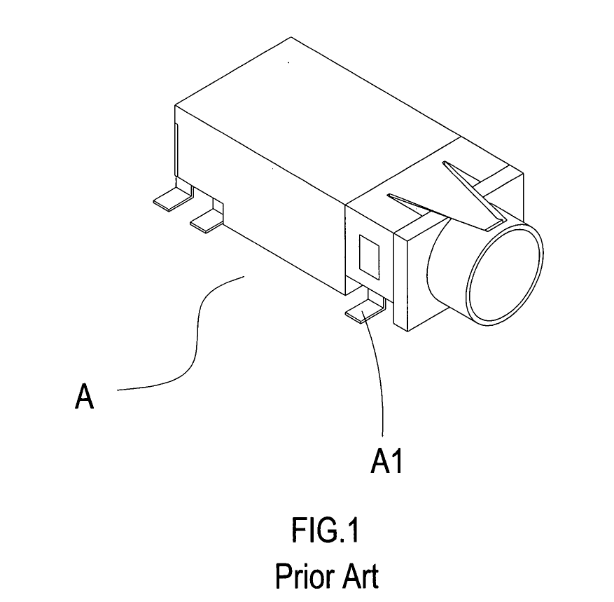

FIG. 2 shows an elevational view of an embodiment of prior art.

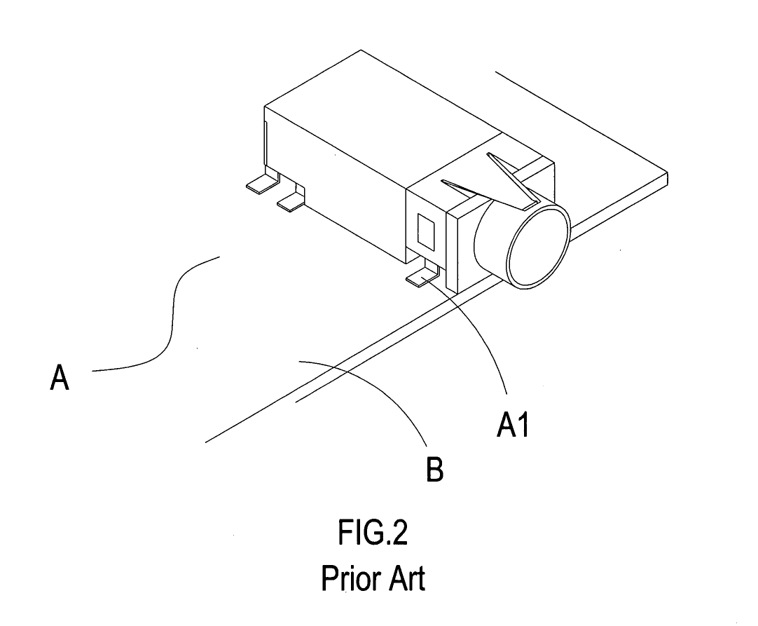

FIG. 3 shows an elevational view according to the present invention.

FIG. 4 shows a sectional schematic view according to the present invention.

FIG. 5 shows an elevational schematic view of a first embodiment according to the present invention.

### DETAILED DESCRIPTION OF THE PREFERRED EMBODIMENTS

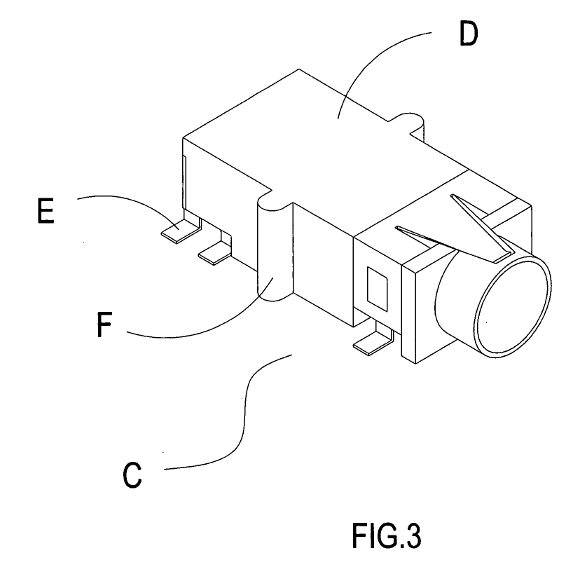

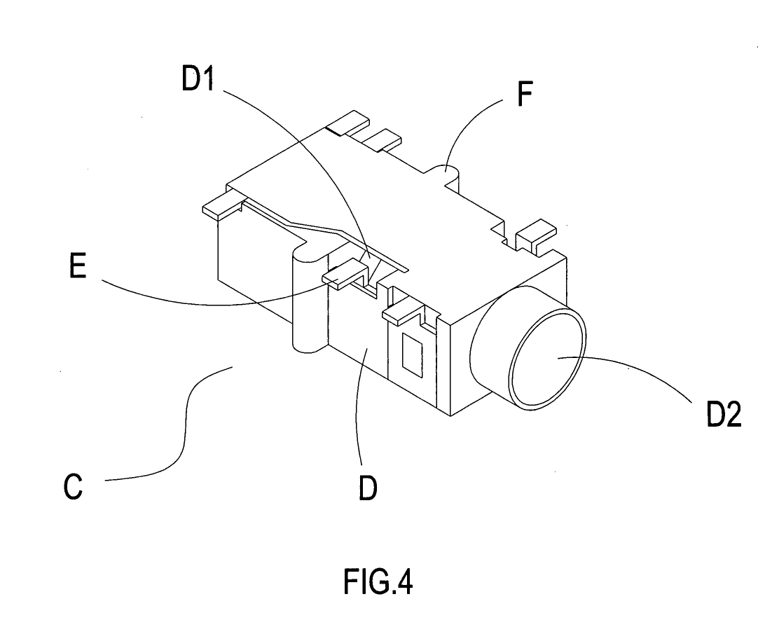

Referring to FIGS. 3 and 4, which show an improved connector structure of the present invention, wherein a connector C is primarily structured to comprise a conducting body D, electric conducting terminals E and fastening members F. A plurality of holes D1 are defined in the conducting body D, and the electric conducting terminals E are respectively located to correspond to the holes D1, thereby enabling the electric conducting terminals E to respectively penetrate the holes D1. Furthermore, when an electrical connection is made to a corresponding containing hole D2 of the conducting body D, then the holes D1 enable an electrical connection to be made to the electric conducting terminals E.

A plurality of mutually corresponding fastening members F extend from the conducting body D, and when the connector C is connected, the fastening members F provide a function to strengthen position fixing of the conducting body D, thereby achieving the objective of effecting a firm fastening installation of the connector C.

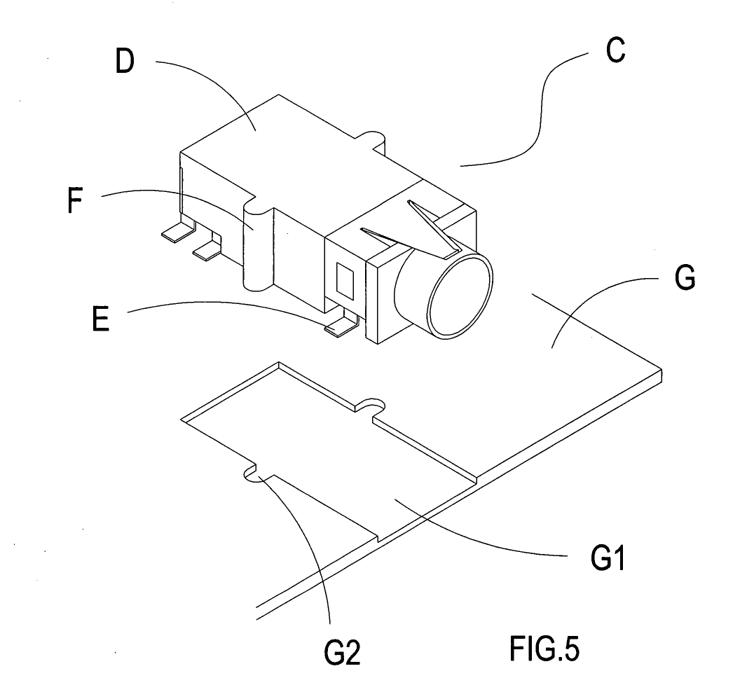

Referring to FIG. 5, which shows an embodiment of the improved connector structure of the present invention provides, wherein the connector C is installed on a circuit board G, on which is defined a hole G1 that enables the connector C to fasten to the circuit board G. Furthermore, corresponding holes G2 are defined and extend from the hole G1, which enable the fastening members F of the connector C to correspondingly fit therein. Hence, when the connector C is joined to the circuit board G, fitting of the conducting body D and the fastening members F into the corresponding hole G1 and the corresponding holes G2 of the circuit board G enable the connector C to be firmly fastened thereto, thereby increasing strength of the function to positionally fix the connector C to the circuit board G.

When the connector C is installed to the circuit board G, the electric conducting terminals E of the connector C are electrical soldered to the circuit board G, thereby achieving effectiveness to provide electric conduction to the connector C, and firmly fastening the connector C to the corresponding holes G2 of the circuit board G by means of the fastening members F extending from the conducting body D, thus enabling the connector C to achieve optimum electric conducting effectiveness.

In order to better explicitly disclose advancement and practicability of the present invention, a comparison with prior art is described hereinafter:

### SHORTCOMINGS OF PRIOR ART

1. Lacks disposition of fastening devices, thereby resulting in the connector of prior art easily rocking on a circuit board.

2. Relies solely on a soldering method to join to a circuit board.

3. Shortcoming 2 causes troublesomeness in that terminals of the connector easily deform or break.

### ADVANTAGES OF THE PRESENT INVENTION

1. Disposition of the fastening members F strengthens position fixing to the circuit board G.

2. The conducting body D and the fastening members F are used to join the connector C to the circuit board G.

3. Advantage 2 resolves the problem of deformation or breaking of the terminals E.

4. Provided with advancement and practicability.

5. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

1-3. (canceled)

4. An electrical connector structure comprising:
a) a conducting body having:
i) a plurality of electric conducting terminals protruding outwardly from each of two opposing sides of the conducting body; and
ii) two fastening members, one of the two fastening members protruding outwardly from each of the two opposing sides of the conducting body and located between two adjacent electric conducting terminals of the plurality of electric conducting terminals, each of the two fastening members having a top surface parallel with a top and a bottom surface parallel with a bottom of the conducting body; and
b) a circuit board having:
i) a circuit board hole; and
ii) two corresponding holes communicating with the circuit board hole,
wherein the bottom portion of the conducting body is inserted into the circuit board hole and a bottom portion of one of the two fastening members is inserted into each of the two corresponding holes,
wherein the plurality of electric conducting terminals are electrically connected to the circuit board.

5. The electrical connector structure according to claim 4, wherein the circuit board hole and the two corresponding holes extend a predetermined distance into a thickness of the circuit board, the predetermined distance is less than the thickness of the circuit board.

6. The electrical connector structure according to claim 4, wherein the conducting body includes a plurality of holes and a containing hole communicating with the plurality of holes, one of the plurality of electric conducting terminals protruding from each of the plurality of holes.
